(19) United States
(12) Patent Application Publication
(10) Pub. No.: US 2013/0083517 A1
(43) Pub. Date: Apr. 4, 2013

(54) Over Door Hanger With Light

(71) Applicant: Janice L. Bratton, Hummelstown, PA (US)

(72) Inventor: Janice L. Bratton, Hummelstown, PA (US)

(21) Appl. No.: 13/251,222

(22) Filed: Oct. 1, 2011

(51) Int. Cl. F21L 4/00

(52) U.S. Cl. 362/191

(57) ABSTRACT

Provided is an illuminated decorative item adapted to be suspended from a dwelling closure, including a hanger bracket that has an upper hook portion for placement over the top of the dwelling closure, a lower support portion and an elongated suspension arm extending there between. A support arm with an attached battery-powered light emitting device extends from the upper hook portion for providing illumination for decorative item which may hang from the lower support portion.

### BRIEF DESCRIPTION OF THE DRAWINGS

FIG. 1 is a side view of a hanger according to an exemplary embodiment of the present invention; and

FIG. 2 is a perspective view of the hanger of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides an over the door hanger with a battery-operated accent light.

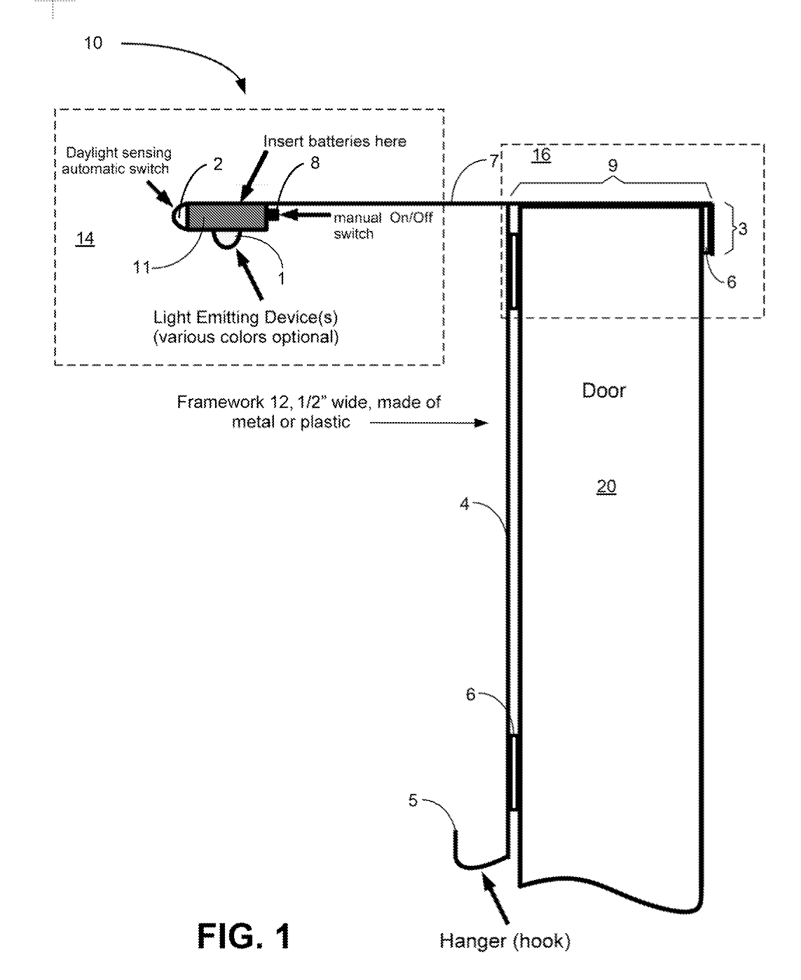

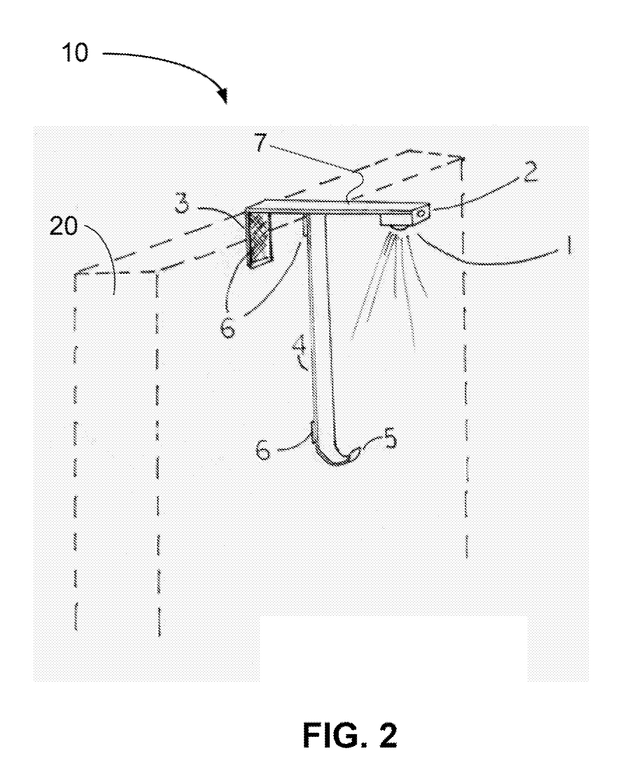

Referring now to FIGS. 1 and 2, different views of a hanger 10 are shown according to an exemplary embodiment of the present invention. The hanger 10 may include a framework 12 and a light subassembly 14 that may be attached to the framework 12. The framework 12 may include a first member 7 and a second member 4. The first member 7 may be positioned horizontally during regular use. A first end of the first member 7 may be bent down about a 90 degree angle to form a retaining tab 3. A first end of the second member 4 may be attached to the lower side of the first member 7 about 2″ apart from the retaining tab 3. The retaining tab 3, the upper portion of second member 4 and a portion of the first member 9 between the retaining tab 3 and the upper portion of the second member 4 may form a rectangular brace 16. The brace may be configured to be disposed on the top side of a door 20. The second member 4 may extend downward along the face of the door 20 and may terminate in a hook 5. The second member 4 may be about 12″ long. The hook 5 may be formed to support a wreath (not shown) or other decoration. The size of the hook 5 may be made to be about 1″-3″. Protective pads 6 made of felt, cork or rubber may be attached to the side of the framework 12 that face the door 20, to protect the finish on the door 20.

The light subassembly 14 may be attached at the second end of the first member 7 of the framework 12. The light subassembly 14 may include a housing 11. A battery (not shown) may be disposed inside the housing 11. A light emitting device (LED) 1 may protrude through the lower side of the housing 11. The LED 1 may be positioned about 3″ from the second member 4. The LED 1 may be able to illuminate about the top ⅓ to ½ portion of the door 20. The light subassembly 14 may include a photo sensor 2 to switch off the light automatically during daylight hours in order to conserve battery life. The light subassembly 14 may also include a manual on/off switch 8 to override the daylight sensor 2.

The framework 12 may be made from about ½″ to 1″ wide, standard sheet metal, the thickness may be varied based on the size and on the raw material used (steel, brass, copper, plastic, etc). The framework 12 may be made by general metal fabrication processes, for example, stamping, laser cutting, bending and spot welding.

It should be understood, of course, that the foregoing relates to exemplary embodiments of the invention and that modifications may be made without departing from the spirit and scope of the invention as set forth in the following claims.

What is claimed is:

1. An over door hanger, comprising:
a framework, the framework being a “T” shaped object having a first member and a second member, the first member being disposed longitudinally, the first member having a first and a second end, the first end of the first member being bent down about 90 degrees, a first end of second member extending orthogonally from the first member along a face of a door, a hook being formed at the second end of the second member to accept a wreath or decoration, a generally rectangular brace formed by the bent down portion of the first member and the first end of the second member, the brace configured to mount on a top of the door; and
a light subassembly affixed to the second end of the first member of the framework, the light subassembly including a housing, a battery disposed inside the housing, a light emitting device protruding through the lower side of the housing, wherein the light emitting device is configured to illuminate about the top ⅓ to ½ portion of the door.
